(19) United States
(12) Patent Application Publication
(10) Pub. No.: US 2015/0088989 A1
(43) Pub. Date: Mar. 26, 2015

(54) SYSTEM AND METHOD FOR GENERATING TEMPORARY SOCIAL NETWORKS

(71) Applicant: International Business Machines Corporation, Armonk, NY (US)

(72) Inventors: David L. Kaminsky, Chapel Hill, NC (US); David M. Ogle, Cary, NC (US); Michael L. Wiles, Raleigh, NC (US)

(73) Assignee: International Business Machines Corporation, Armonk, NY (US)

(21) Appl. No.: 14/032,221

(22) Filed: Sep. 20, 2013

(51) Int. Cl. H04L 29/08

(52) U.S. Cl. CPC H04L 67/24
USPC 709/204

(57) ABSTRACT

A method and system for generating temporary social networks on a communications network includes creating a temporary social network for a plurality of users based on one or more criteria using a program. The program is executable by a processor of a computer. The temporary social network is accessible using a communications network. Contacts are searched in a user contact list based on the criteria. The contacts are joined to the temporary social network. The temporary social network is removed according to a policy.

### BACKGROUND

1. Field

The present disclosure relates to a method and system for generating a temporary social network on a communications network for a plurality of users.

2. Background of the Disclosure

The use of social networks is prevalent for accessing and soliciting opinions from other users, which may include friends and contacts. A user can access opinion information and reviews to, for example, inquiring about a restaurant, or where to shop. For example, typical websites which are accessible using the Internet allow users to inquire about a restaurant in the area of the user, or a specified area, to review the establishment. Other services via the Internet allow users to find nearby friends, and broadcast the user's location to find local buying options.

### BRIEF SUMMARY

It would be desirable for a user to be able to group other users in a social network based on specific data or information, such as, information pertaining to a specified situation, location, or interest.

In an aspect according to the invention, a method for generating temporary social networks on a communications network includes creating a temporary social network for a plurality of users based on a criterion using a program. The program is executable by a processor of a computer. The temporary social network is accessible using a communications network. Contacts are searched in a user contact list based on the criterion. The contacts are joined to the temporary social network. The temporary social network is removed according to a policy.

In another aspect according to the invention, a computer program product for generating temporary social networks on a communications network, wherein the computer program product comprises a computer readable storage device having program code embodied therewith. The program code is readable/executable by a processor to perform a method, comprising the steps of: creating a temporary social network for a plurality of users based on a criterion using a program, the program being executable by a processor of a computer, the temporary social network being accessible using a communications network; searching for contacts in a user contact list based on the criterion; joining the contacts to the temporary social network; and removing the temporary social network according to a policy.

In another aspect according to the invention, a system for generating temporary social networks on a communications network includes a communications device configured to creating a temporary social network for a plurality of users based on a criterion using a program. The program is embodied on a computer readable storage device and executable by a processor of a computer. The temporary social network is accessible using a communications network, and the program has program modules including code or instructions for: searching for contacts in a user contact list based on the criterion; joining the contacts to the temporary social network; and removing the temporary social network according to a policy.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a schematic block diagram illustrating an overview of the system and methodology for generating temporary social networks on a communications network according to an embodiment of the disclosure;

FIG. 2 is a flow chart illustrating a method for generating temporary social networks on a communications network according to an embodiment of the disclosure; and

FIG. 3 is a flow chart continuing from the flow chart shown in FIG. 2 illustrating another embodiment of the disclosure.

### DETAILED DESCRIPTION

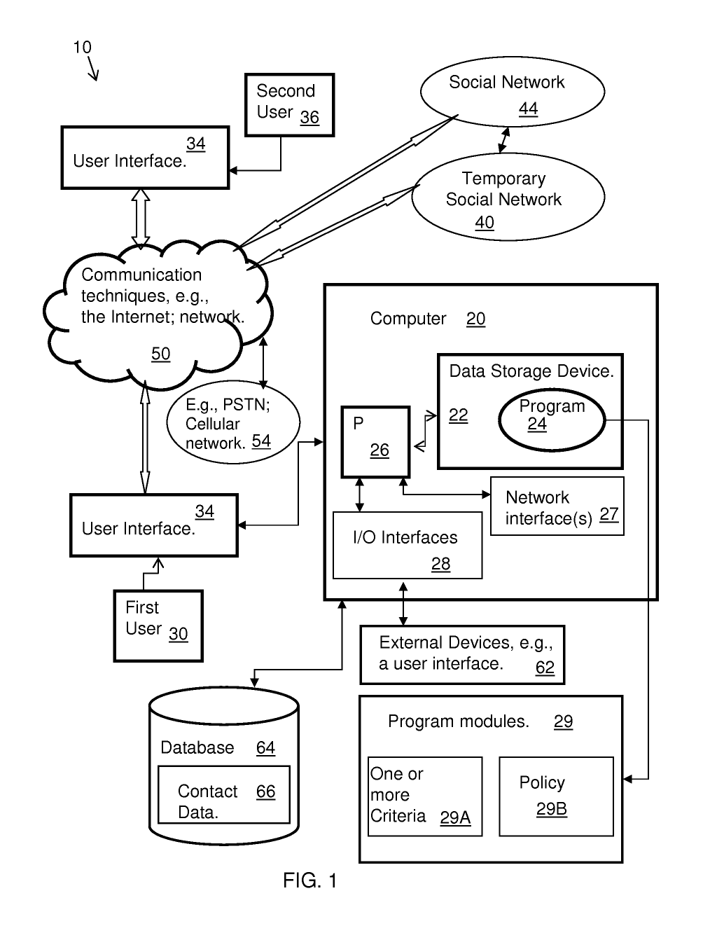

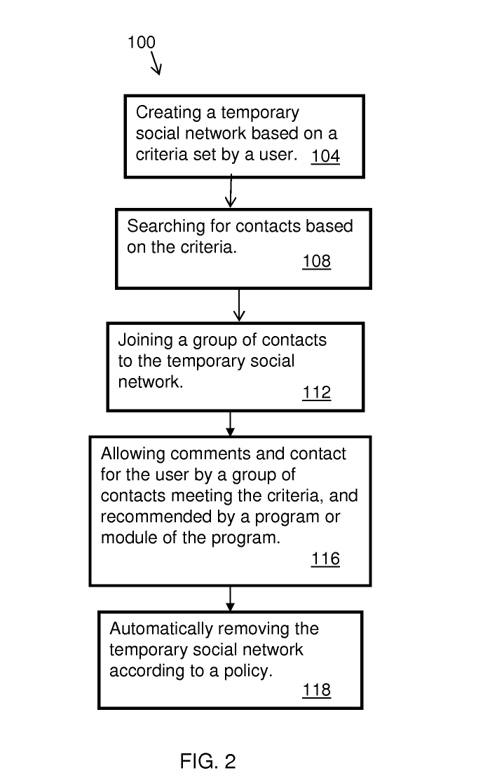

Referring to FIGS. 1 and 2, a system 10 and method 100 according to an embodiment of the disclosure for generating one or more temporary social networks is discussed below. The temporary social network may also be referred to as a temporary common interest based network. The system 10 includes a communications system or technique 50, which may be embodied as the Internet. The communications system 50 may also include, for example, a public switched telephone network (PSTN) for example, a cellular network 54. The PSTN may include telephone lines, fiber optic cables, microwave transmission links, cellular networks, and communications satellites. The communications system 50, using interaction with a mobile/cellular network for a mobile device, may provide communication with a user interface, for example, a personal data assistant (PDA) or digital assistant; a computer, a tablet, a cell phone, or other mobile device, a laptop, a notebook, a cell phone, a netbook, a PDA, or a car communication system.

A temporary social network 40 according to the present disclosure can be based on a criterion defined by a user 30 and uses the communications network 50. A multiplicity of criteria can also be defined by the user. A program 24 for performing the method 100 is embodied on a data storage device 22 of a computer 20 and is executable by a processor 26. The data storage device or medium may include a hard drive, flash drive, etc. A user interface 34 may be used to input data, for initiating and accessing the temporary social network. The user interface 34 generically represents one or more devices for interaction with a user, for example, the devices discussed above. The user interface 34 may also include a keyboard, or a touch screen, etc.

The program or executable instructions therefrom, may be offered as a service by a provider. The program may be an add-on or sub-program to an existing program, such as an addition to a website providing shopping recommendations. The program may also be stored and run locally on a user device. The computer 20 and program 26 shown in FIG. 1 are generic representations of a computer and program that may be local to a user, or provided as a remote service, such as a website accessible using the Internet. The computer 20 also generically represents a computer device such as a personal data assistant, a laptop, or desktop computer, etc., or part of one or more servers, alone or as part of a datacenter. The computer system 20 can include a network interface 27, and input/output (I/O) interface(s) 28. The I/O interface 28 allows for input and output of data with an external device 62 that may be connected to the computing device. The network interface 27 may provide communications between the computing device and a computer network. The program 24 may include program modules 29 for executing specific steps, routines, sub-routines, instructions or code, of the program. Such modules 29 are generically represented, and discussed below in more detail.

The temporary social network 40 may be a website on one or more host servers accessible via the Internet by multiple users. The temporary social network 40 may be added to an existing social network 44 or share data with the existing social network 44. The communications network 50 may include communication/conversations between multiple users (generically represented as a first user 30 and a second user 36) using PDAs, or computers, which facilitate communications using texting, messaging, postings on social websites, posting on blogs, and the like.

Referring to step 104 of the method 100 shown in FIG. 2, the method creates the temporary social network 40 based on a criterion 29A set by the first user 30 via the communications network 50 using the program 24. Step 108 includes searching for contacts based on the criterion 29A. The contacts, for example, can be in the first user's 30 address book of their device, or alternatively on a social network 44 that they belong to. The contacts 66 may be stored on a database 64.

Step 112 includes joining a group of the contacts to the temporary social network 40. In the embodiment of the disclosure shown in FIG. 1, the second user 36 represents one or more of a group of contacts that are joined to the temporary social network. Step 116 includes allowing comments and contact between the user and the group of contacts meeting the criterion. Further, recommendations for contacts can be created, which can be accepted at the first user's discretion. The second user(s) can also be presented with an option to join the temporary social network 40 and accept or decline the invitation. The temporary social network can include posting messages, and delivering messages. Messages can be delivered from the temporary social network during a specified active period, or during the life of the temporary social network.

Step 118 includes automatically removing the temporary social network according to a policy 29B. The policy for the automatic removal of the social network may be based on the absence of the criterion. For example, the criterion may include a spatial parameter, for example a location of the user and/or a destination, and when the first user or no users meet that criterion, the temporary social network is removed.

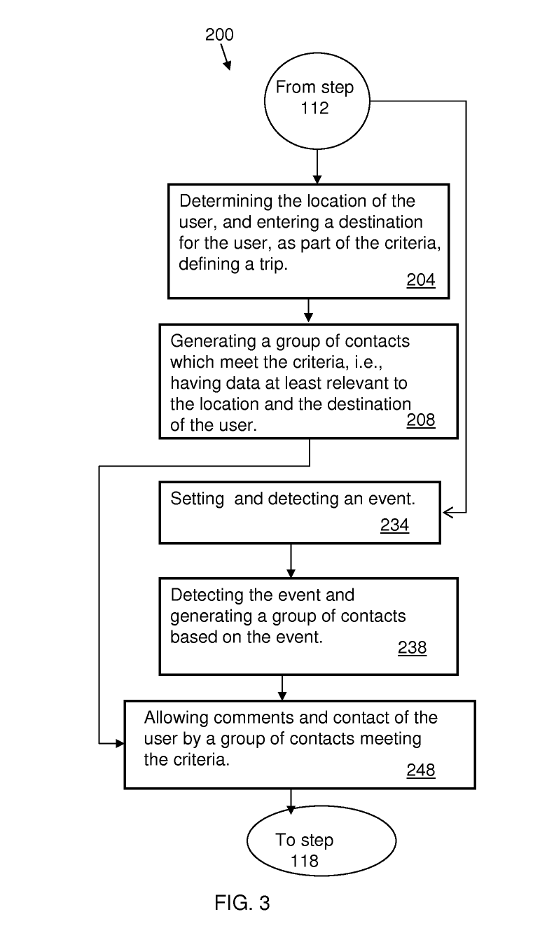

Referring the FIG. 3, a method 200 optionally continues from step 112 of the method 100 shown in FIG. 2. Step 204 includes determining the location of the user, and entering a destination of the user, as part of the criterion which defines a trip. For example, the location of the user may be manually entered or automatically determined using a GPS (global positioning system). The user can enter a destination for a trip into the program using, for example, a hand held device. Step 208 includes generating a group of contacts meeting the criterion, wherein the group of contacts can comment and offer suggestions relevant to the trip, as in step 248. The method 200 then returns to step 118 of the method 100 regarding removal of the temporary social network.

In an alternative embodiment of method 200, step 234 includes the first user setting an event as a criterion for generating the temporary social network. A multiplicity of events can also be set as criteria. Step 238 includes detecting the event and generating a group of contacts based on the criterion, i.e., the event. The method 200 generates additional contacts based on the event when the event is detected. The group of contacts can comment and offer suggestions relevant to the event, as in step 248. The method 200 then returns to step 118 of the method 100 regarding removal of the temporary social network.

The method steps and system features described above may be embodied in modules of the program for performing the steps of the method (or also can be referred to as tools, or a tool of the program), which are generically represented in FIG. 1 as program modules 29. Further embodiments, aspects, and variations according to the methods 100, 200 of the present disclosure are discussed below and may be embodied as modules 29 of the program 24 for executing the method.

Furthermore, regarding the embodiments disclosed herein, the contacts may include a group of contacts extracted from a contact list on the user PDA, or from the social network 44. The criterion 29A may include locations, such as present location and future destination, or an event, such as a natural disaster, car emergency, or traffic jam. The criterion may further include one or more of: a friend, an age range, a preference, a follower, a blog, a category, a like, a dislike, a discount, an ethnic food, an occupation, a membership, an accident, or a weather condition. The policy 29B may include a duration of time for the temporary social network to exist. The time duration may be set by the user, or be contingent on an event occurring or not occurring, or other condition occurring or not occurring.

The method 100 can be an addition to an existing social network where data content including, for example, messaging, preferences, comments, is augmented with a temporary social network with data from the user and soliciting comments from other users of the social network. As the method 100 augments the data of an existing social network, new sets of queries on the exiting data are possible. For example, the user may enter a location and solicit comments about traffic conditions. Alternatively, the user may enter an event and invite comments, for example, looking for restaurants in area for dinner at 6 pm, and include a current location, such that the method solicits comments from users in the social network. The temporary social network would automatically be removed after 6 pm, or similarly for other instances, after a defined event occurs.

The above examples also can be applied where a temporary social network is created via multiple user interfaces, such as computers, PDAs, etc. The method automatically can search for contacts based on the criterion and generate a group of users. This group can be presented to the user as recommended friends. The group of contacts can be generated from exiting contact list, and also from other public networks where information is available for the method to check for the criterion set by the user and generate a contact list of potential friends or user for the created temporary group.

Further, examples of one or more criteria, including events, may include setting a dynamic group of people, for example, one or more of, a number of people, an age group for people, various likes and dislikes, for example, dietary requirements. For example, a senior citizen can be temporarily added to the temporary social network, by meeting a set criteria, so that common interests and tastes are shared with the user. The methods 100, 200 can use data mining techniques to build (and destroy) new temporary social networks dynamically. Other examples of temporarily social networks may include a criteria that includes people in an age range, such as, ages 25-50, and that live near the epicenter of a recent earthquake (e.g., August 23rd earthquake near a specified city and State. Soldiers in the military that are currently stationed in a specified Country, and city. Age or other demographic ranges living within a specified distance of a home or other property a user is considering purchasing. Thus, the temporary social network criteria may be about a current event or interest, a past event or interest, or a possible future event or interest.

Other embodiments and variations of the presently disclosed embodiments can include using “likes” and “dislikes” so that a user can contribute to the other users in temporary social network. Further, the method can detect an event included in the criteria, for instance using the Internet, thereupon create a temporary social network upon detecting the event. Further, a policy 29B can be set for the criteria, for instance, limiting the size of the temporary social network.

Thus, the method and system according to the present disclosure can include setting a criteria which includes an event, and detecting the event, and generating additional contacts based on the event. The criteria can include a spatial parameter and/or a location, the location can be the location of the user who created the temporary social network. The criteria can include a destination location of the user. The contacts used to build the temporary social network can include a group of contacts extracted from a contact list of a mobile device, computer, or another social network, a social group, a user-to-user network, a subscription, or any type of following. The criteria can further includes one or more of: a friend, an age range, a preference, a follower, a blog, a category, a like, a dislike, a discount, an ethnic food, an occupation, a membership, an accident, or a weather condition. Further, the method can include initiating alerts to a user based on detection of an event. The criteria can also include a characteristic such as: a friend, an age range, a preference, a follower, a blog, a category of interest, a like, a dislike, a discount, an ethnic food, an occupation, a list, a membership, an accident, and a weather condition.

While embodiments of the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

Therefore, one or more Figures described herein may illustrate a schematic of an embodiment of the disclosure and may include a representative computer system or processing system that may implement a method and a program in one or more embodiments of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with one or more processing systems in the present disclosure may include, but are not limited to, personal computer systems, server computer systems, handheld or laptop devices, multiprocessor systems, microprocessor-based systems, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units, a system memory, and a bus that couples various system components including system memory to processor. Computer system may include a variety of computer system readable media. Such media may be any available media that is accessible by computer system, and it may include both volatile and non-volatile media, removable and non-removable media. System memory 58, shown in FIG. 1, can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices such as a keyboard, a pointing device, a display, etc.; one or more devices that enable a user to interact with computer system; and/or any devices (e.g., network card, modem, etc.) that enable computer system to communicate with one or more other computing devices. Such communication can occur via Input/Output (I/O) interfaces. Additionally, computer systems can communicate with one or more networks such as a local area network (LAN), a general wide area network (WAN), and/or a public network (e.g., the Internet) via network adapter. As depicted, network adapter communicates with the other components of computer system via bus. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

Additionally, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Further, any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart(s) and block diagrams as may be illustrated in the one or more Figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments, features, and instructive examples described above are illustrative, and should not be construed to limit the present disclosure to the particular embodiments or enumerated examples. Thus, various changes and modifications may be effected by one skilled in the art without departing from the spirit or scope of the disclosure as defined in the appended claims.

What is claimed is:

1. A method for generating temporary social networks on a communications network, comprising:
creating a temporary social network for a plurality of users based on a criterion using a program, the program being executable by a processor of a computer, the temporary social network being accessible using a communications network;
searching for contacts in a user contact list based on the criterion;
joining the contacts to the temporary social network; and
removing the temporary social network according to a policy.

2. The method of claim 1, wherein the removing of the temporary social network is automatic according to the policy.

3. The method of claim 1, wherein the policy for automatic removal of the social network is based on the absence of the criterion.

4. The method of claim 1, wherein the criterion includes an event.

5. The method of claim 1, wherein the criterion includes an event, and the method further comprising:
detecting the event; and
generating additional contacts based on the event.

6. The method of claim 1, wherein the criterion includes a spatial parameter.

7. The method of claim 1, wherein the criterion includes a location.

8. The method of claim 1, wherein the criterion includes a location of a user who created the temporary social network.

9. The method of claim 1, wherein the criterion includes a location of a user who created the temporary social network and a destination location of the user.

10. The method of claim 1, wherein the contacts include a group of contacts being extracted from a contact list.

11. The method of claim 1, wherein the contacts include a group of contacts extracted from an on-line social group.

12. The method of claim 1, wherein the policy includes a duration of time for the temporary social network.

13. The method of claim 1, wherein the criterion includes one or more of: a friend, an age range, a preference, a follower, a blog, a category, a like, a dislike, a discount, an ethnic food, an occupation, a membership, an accident, or a weather condition.

14. The method of claim 1, further comprising:
initiating alerts to a user based on detection of an event.

15. The method of claim 1, wherein the temporary social network is selected from a group which includes: a social group, a user-to-user network, a subscription, and a following.

16. The method of claim 1, wherein one or more criteria include a location and an event, and a time period for the location and/or the event.

17. The method of claim 1, wherein the criterion includes a characteristic including: a friend, an age range, a preference, a follower, a blog, a category of interest, a like, a dislike, a discount, an ethnic food, an occupation, a list, a membership, an accident, and a weather condition.

18. A computer program product for generating temporary social networks on a communications network, the computer program product comprising a computer readable storage device having program code embodied therewith, the program code being readable/executable by a processor to perform a method, comprising the steps of:
creating a temporary social network for a plurality of users based on a criterion, the temporary social network being accessible using a communications network;
searching for contacts in a user contact list based on the criterion;
joining the contacts to the temporary social network; and
removing the temporary social network according to a policy.

19. The computer program product of claim 18, wherein the policy for automatic removal of the social network is based on the absence of the criterion.

20. A system for generating temporary social networks on a communications network, which comprises:
a communications device configured to creating a temporary social network for a plurality of users based on a criterion using a program, the program embodied on a computer readable storage device and being executable by a processor of a computer, the temporary social network being accessible using a communications network, the program having program modules including code or instructions for:
searching for contacts in a user contact list based on the criterion;
joining the contacts to the temporary social network; and
removing the temporary social network according to a policy.
